(19) United States
(12) Patent Application Publication
(10) Pub. No.: US 2013/0244684 A1
(43) Pub. Date: Sep. 19, 2013

(54) PERMISSIONS BASED ON WIRELESS NETWORK DATA

(71) Applicants: Mohammed Waleed Kadous, Sunnyvale, CA (US); Isaac Richard Taylor, Mountain View, CA (US); Cedric Dupont, San Francisco, CA (US); Brian Patrick Williams, Mountain View, CA (US); Sorelle Alaina Friedler, San Francisco, CA (US)

(72) Inventors: Mohammed Waleed Kadous, Sunnyvale, CA (US); Isaac Richard Taylor, Mountain View, CA (US); Cedric Dupont, San Francisco, CA (US); Brian Patrick Williams, Mountain View, CA (US); Sorelle Alaina Friedler, San Francisco, CA (US)

(73) Assignee: GOOGLE INC., Mountain View, CA (US)

(21) Appl. No.: 13/419,007

(22) Filed: Mar. 13, 2012

(51) Int. Cl. H04W 4/02; H04W 64/00

(52) U.S. Cl. 455/456.1; 455/418

(57) ABSTRACT

Aspects of the present disclosure relate generally to using position information to grant access. More specifically, wireless network access point data may be used to identify the location of a mobile device in an indoor space. If the identified location is associated with permission information, this information may be used by a permission device to grant or deny the user of the client device some right. For example, the permission information may be used to unlock a door, lock or unlock a feature on the mobile device, delay some action, etc.

### BACKGROUND

Modern smartphone devices are equipped with location-based features. These devices use signals from GPS satellites to identify a location, determine a direction of motion, and other navigation functions. However, in locations where the GPS satellite signals are weak, for example, when these devices are indoors, GPS may not function well or at all.

As an alternative, these devices may use other information, such as wireless network signals, Bluetooth, compasses and accelerometers as well as existing floor plans and pre-generated databases or indices of measurements.

### SUMMARY

One aspect of the disclosure provides a method for generating permission signals associated with an indoor space. The method includes receiving user information identifying a user and receiving scan information from a scan conducted in an indoor space. The scan information includes wireless network access points and associated signal strengths. The method also includes determining a location by comparing the scan information to a model of the indoor space. The model includes wireless network access points and signal strengths for locations in the indoor space. The method includes identifying permission data associated with a user of a client device based on the user information. The permission data identifies a set of locations of in the indoor space, and each particular location of the set of locations is associated with a particular rule. The method also includes identifying a rule based on the determined location. A processor generates a permission signal based on the rule. The permission signal includes instructions concerning permission to perform a task.

The method also includes transmitting the permission signal to a permission device for performing the task.

In one example, the processor that generates the permission signal is a processor of the client device. In another example, the processor that generates the permission signal is a processor of a server computer that receives the scan information from the client device. In another example, the permission signal includes information instructing the permission device to unlock a door. In another example, the permission signal includes information instructing the permission device not to unlock a door. In another example, the permission signal includes information instructing the permission device to delay an action of the permission device. In another example, the permission signal includes information instructing the permission device to deny a transaction associated with the user. In another example, the method also includes determining a distance between the identified location and the location of the permission device, and the permission signal is also generated based on the determined distance. In another example, the method also includes receiving a request to delay an action from a pre-determined number of client devices, and the permission signal is further generated only after the information received from the pre-determined number of client devices. In another example, the method also includes receiving orientation information from one or more orientation devices and comparing the received orientation information to a mode model to determine a mode of the client device. In this example, the mode model defines how the client device is being carried by the user, and identifying the permission data is also based on the determined mode of the client device. In another example, determining the location by comparing the scan information to a model of the indoor space includes calculating a latitude coordinate and a longitude coordinate.

Another aspect of the disclosure provides a method. The method includes receiving user information identifying a user and scanning for scan information including wireless network access points and associated signal strengths. A processor determines a location by comparing the scan information to a model of the area in which the scan was performed. The model includes wireless network access points and signal strengths for locations in the area. The method also includes identifying permission data associated with a user of a client device based on the user information. The permission data identifies a set of locations of in the area, and each particular location of the set of locations is associated with a particular rule defining an access right to a feature of the client device. The method includes identifying a rule based on the determined location and performing an action based on the access right to the feature of the client device associated with the identified rule.

In one example, the identified rule involves restricting the ability to make telephone calls at the client device and the action is denying the user the ability to make non-emergency telephone calls at the client device. In another example, the identified rule involves restricting the ability to send or receive text messages at the client device and the action is denying the user the ability to send and receive text messages. In another example, the identified rule involves restricting the ability to complete a business transaction using the client device and action includes denying the user the ability to complete a business transaction associated with the user. In another example, the identified rule involves enabling the user to complete a business transaction using the client device and action includes enabling the user to complete a business transaction associated with the user. In another example, the method also includes transmitting a request to a server. The request includes the user information and information identifying the indoor space and, in response to the request, receiving the map of the indoor space and the permission information. In another example, the method also includes receiving orientation information from one or more orientation devices, and comparing the received orientation information to a mode model to determine a mode of the client device. In this example, the mode model defines how the client device is being carried by the user and how the user is moving through the area and identifying the permission data is also based on the determined mode of the client device. In another example, determining the location by comparing the scan information to the model of the area includes calculating a latitude coordinate and a longitude coordinate.

Yet another aspect of the disclosure provides a tangible computer-readable storage medium on which computer readable instructions of a program are stored. The instructions, when executed by a processor, cause the processor to perform a method of generating permission data associated with an indoor space. The method includes receiving user information identifying a user and receiving scan information including wireless network access points and associated signal strengths. The scan information is from a scan conducted in the indoor space. The method also includes determining a location by comparing the scan information to a model of the indoor space. The model includes wireless network access points and signal strengths for locations in the indoor space. The method includes identifying permission data associated with a user of a client device based on the user information. The permission data identifies a set of locations of in the indoor space, and each particular location of the set of locations is associated with a particular rule. The method also includes identifying a rule based on the determined location and generating a permission signal based on the rule. The permission signal includes instructions concerning permission to perform a task. The method also includes transmitting the permission signal to a permission device for performing the task.

A further aspect of the disclosure provides a tangible computer-readable storage medium on which computer readable instructions of a program are stored. The instructions, when executed by a processor, cause the processor to perform a method. The method includes receiving user information identifying a user and scanning an area for scan information including wireless network access points and associated signal strengths. The method also includes determining a location by comparing the scan information to a model of the area. The model includes wireless network access points and signal strengths for locations in the area. The method includes identifying permission data associated with a user of a client device based on the user information. The permission data identifies a set of locations of in the area, and each particular location of the set of locations is associated with a particular rule defining an access right to a feature of the client device. The method also includes identifying a rule based on the determined location and performing an action based on the access right to the feature of the client device associated with the identified rule.

Another aspect of the disclosure provides a device. The device includes memory storing a model of an indoor space. The model includes wireless network access points and signal strengths for locations in the area. The memory also stores permission data associated with a user of the device. The permission data identifying a set of locations of in the area, and each particular location of the set of locations is associated with a particular rule. The device also includes a processor coupled to the memory. The processor is configured to collect scan information in the indoor space. The scan information includes wireless network access points and associated signal strengths. The processor is also configured to determine a location by comparing the scan information to the model of the area and to identify a rule from the stored permission data based on the determined location.

In one example, the processor is also operable to perform an action based on the access right to the feature of the device associated with the identified rule. In another example, the processor is also configured to generate a permission signal based on the rule and transmit the permission signal to a permission device to perform the task. In this example, the permission signal includes instructions concerning permission to perform the task.

Yet another aspect of the disclosure provides a device. The device includes memory storing a model of an area. The model includes wireless network access points and signal strengths for locations in the area. The memory also stores sets of permission data. Each set of permission data is associated with a given user and identifiable based on user information for the given user. Each set of permission data also a set of locations of in the area and each particular location of the set of locations is associated with a particular rule. The device also includes a processor coupled to the memory. The processor is configured to receive user information and scan information including wireless network access points and associated signal strengths. The scan is conducted in the area. The processor is also configured to identify permission data associated based on the received user information, determine a location by comparing the scan information to the model of the area, and identify a rule from the identified permission data based on the determined location.

In one example, the processor is also configured to perform an action based on the access right to the feature of the device associated with the identified rule. In another example, the processor is also operable to generate a permission signal based on the rule and transmit the permission signal to a permission device to perform the task. In this example, the permission signal includes instructions concerning permission to perform the task.

### BRIEF DESCRIPTION OF THE DRAWINGS

FIG. 1 is a functional diagram of a system in accordance with an implementation.

FIG. 2 is a pictorial diagram of the system of FIG. 1.

FIG. 3 is a top down view of an indoor space in accordance with an implementation.

FIG. 4 is a map of the indoor space of FIG. 3 in accordance with an implementation.

FIG. 5 is a wireless network access point model of the indoor space of FIG. 3 in accordance with an implementation.

FIG. 6 is permission data in accordance with an implementation.

FIG. 7 is another top down view of the indoor space of FIG. 3 in accordance with an implementation.

FIG. 8 is another map of the indoor space of FIG. 3 in accordance with an implementation.

FIG. 9 is a flow diagram in accordance with an implementation.

FIG. 10 is another flow diagram in accordance with an implementation.

FIG. 11 is a further flow diagram in accordance with an implementation.

FIG. 12 is another flow diagram in accordance with an implementation.

### DETAILED DESCRIPTION

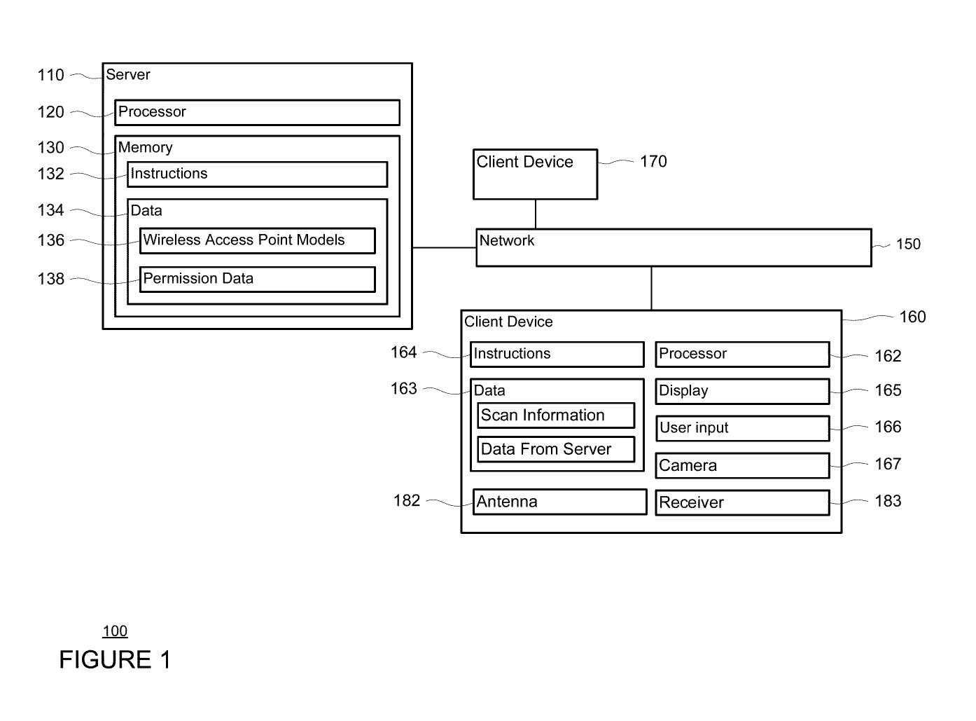

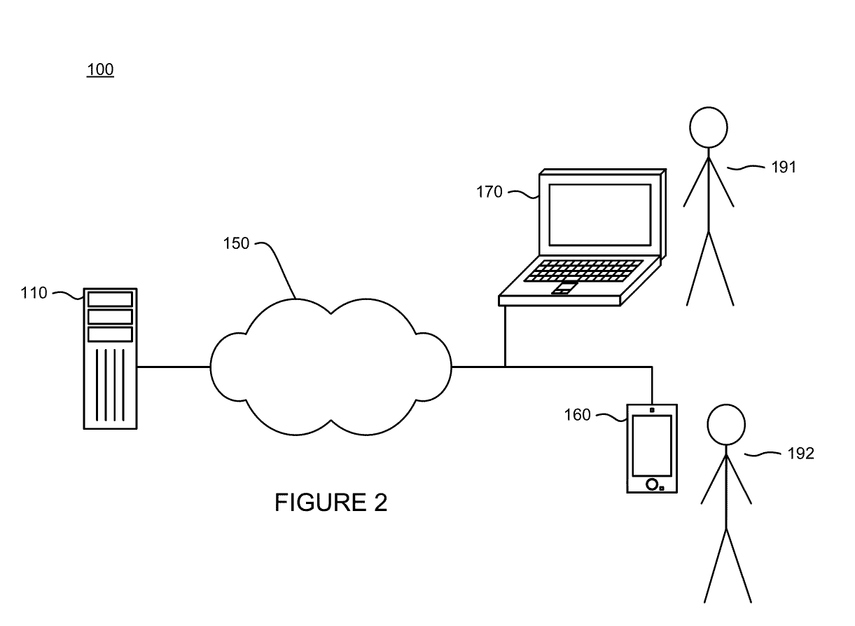

As shown in FIGS. 1-2, a system 100 for use with an implementation includes a computer 110 containing a processor 120, memory 130 and other components typically present in general purpose computers.

The memory 130 stores information accessible by processor 120, including instructions 132, and data 134 that may be executed or otherwise used by the processor 120. The memory 130 may be of any type capable of storing information accessible by the processor, including a computer-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computer code on the computer-readable medium. In that regard, the terms “instructions” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

The data 134 may be retrieved, stored or modified by processor 120 in accordance with the instructions 132. For instance, although the system and method is not limited by any particular data structure, the data may be stored in computer registers, in a relational database as a table having a plurality of different fields and records, XML documents or flat files. The data may also be formatted in any computer-readable format. By further way of example only, image data may be stored as bitmaps comprised of grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data may comprise any information sufficient to identify the relevant information, such as numbers, descriptive text, proprietary codes, references to data stored in other areas of the same memory or different memories (including other network locations) or information that is used by a function to calculate the relevant data.

The processor 120 may be any conventional processor, such as commercially available CPUs. Alternatively, the processor may be a dedicated controller such as an ASIC or other hardware-based processor. Although FIG. 1 functionally illustrates the processor and memory as being within the same block, it will be understood by those of ordinary skill in the art that the processor and memory may actually comprise multiple processors and memories that may or may not be stored within the same physical housing. For example, memory may be a hard drive or other storage media located in a server farm of a data center. Accordingly, references to a processor, memory, or computer will be understood to include references to a collection of processors, memories or computers that may or may not operate in parallel.

The computer 110 may be at one node of a network 150 and capable of directly and indirectly communicating with other nodes of the network. For example, computer 110 may comprise a web server that is capable of communicating with client devices 160 and 170 via network 150 such that server 110 uses network 150 to transmit and present information to a user on display 165 of client device 160. Server 110 may also comprise a plurality of computers that exchange information with different nodes of a network for the purpose of receiving, processing and transmitting data to the client devices. In this instance, the client devices will typically still be at different nodes of the network than any of the computers comprising server 110.

The server 110 and client computers 160 and 170 are capable of direct and indirect communication, such as over network 150. Although only a few computers are depicted in FIGS. 1-2, it should be appreciated that a typical system can include a large number of connected computers, with each different computer being at a different node of the network 150. The network, and intervening nodes, may comprise various configurations and protocols including the Internet, World Wide Web, intranets, virtual private networks, wide area networks, local networks, private networks using communication protocols proprietary to one or more companies, Ethernet, WiFi (such as 802.11, 802.11b, g, n, or other such standards), and HTTP, and various combinations of the foregoing. Such communication may be facilitated by any device capable of transmitting data to and from other computers, such as modems (e.g., dial-up, cable or fiber optic) and wireless interfaces.

Each client device may be configured similarly to the server 110, with a processor, memory and instructions as described above. Each client device 160 or 170 may be a personal computer intended for use by a person 191-192, and have all of the components normally used in connection with a personal computer such as a central processing unit (CPU) 162, memory (e.g., RAM and internal hard drives) storing data 163 and instructions 164, an electronic display 165 (e.g., a monitor having a screen, a touch-screen, a projector, a television, a computer printer or other device that is operable to display information), end user input 166 (e.g., a mouse, keyboard, touch-screen or microphone). The client device may also include a camera 167, speakers, a network interface device, and all of the components used for connecting these elements to one another.

Although the client devices 160 and 170 may each comprise a full-sized personal computer, they may alternatively comprise mobile devices capable of wirelessly exchanging data with a server over a network such as the Internet. By way of example only, client device 160 may be a wireless-enabled PDA, a cellular phone, a tablet PC, or a netbook capable of obtaining information via the Internet. The user may input information using a small keyboard (in the case of a PDA-type phone), a keypad (in the case of a typical cellular phone) or a touch screen (in the case of a PDA).

Client device 160 and/or 170 may also operate as a permission device. As described in more detail below, upon receipt of a permission signal, a permission device may take some action to grant or deny a client device some access right with regard to a particular indoor space. Thus, in some examples, antenna 182 and receiver 183 may also operate to receive permission signals and send them to the processors 162 for further review or action.

The client devices may include an antenna 182 and receiver 183 which may be used to scan the wireless network spectrum and identify local wireless network signals. For example, many wireless network access points may operate in the 2.4 GHz frequency band and the signals may be based on 802.11, 802.11b, g, n, or other such standards. The access point may transmit and the antenna may receive “beacon” messages according to the aforementioned standards. The antenna may send the beacon messages to the receiver which demodulates the information to identify wireless network access points and associated signal strengths. In one example, these beacon messages may be IEEE 802.11 management frames transmitted by access points to announce themselves to potential wireless network users. These frames may contain Service Set Identifiers (“SSID”) information as well as physical layer parameters that assist devices in connecting to the wireless network. The beacon messages may also include additional network access information which also assists devices in accessing the network, including whether the access point is accepting new users, whether the data is encrypted, and which type of authentication is being used, for example, no authentication (open to all), password based, web-portable based, or Media Access Control (“MAC”) address based.

Data collected in accordance with this disclosure may be limited to the information discussed above, for example MAC addresses, SSIDs or other identifiers and signal strengths, and need not contain additional information. For example, information contained in the network traffic or payload data, such as personal information, need not be collected, and in fact, may actually be removed in order to protect the privacy of the wireless network's users.

Accordingly, data 163 of the client device may include the scan information collected as received and processed as described above. For example, the scan information may include wireless network access point identifies (such as SSIDs and/or MAC addresses) as well as the associated signal strengths. Again, this information need not include any payload data or personal information.

Instructions 164 of the client device may include a permission application. In one example, a user may download a permission application onto his or her client device. The permission application may allow the user's client device to send and receive information such as scan information and user information as well as wireless network access point model data, permission data, and permission signals with over devices as described in more detail below.

The user data may be input by a user and stored in data 163. User information may be used by a client device to identify the user of the device or the device itself to other devices of network 150. For example, the user information may include login information such as user names, passwords or passphrases, device identifiers, etc.

The client devices may also receive and store data provided by the server, including, for example all or portions of the wireless network access point models and permission data described in detail below.

Data 134 of server 110 may include wireless network access point models 136. The models may include the outline of an indoor space such as a building. For example, a footprint as well as include various constraints within the footprint such as walls, windows, doors, and other features as well as measurements or reference data sufficient for the computer to determine the length of a wall or size of a room, etc. The model may also be associated with wireless network access point data describing the expected wireless network access point signals and corresponding signal strengths expected to be detected by a device scanning for such signals at different locations of the map. The expected wireless network access point signals may be specific values or may be a range of values.

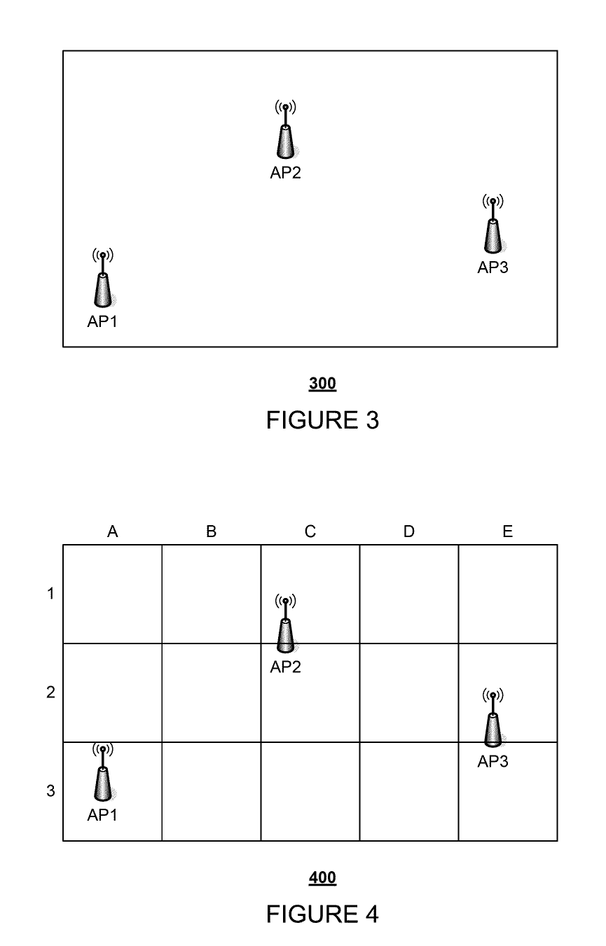

FIG. 3 is a top down view of an example indoor space. While the examples used herein include fairly simple open spaces, it will be understood that floor plans (or maps) in accordance with the aspects disclosed herein may be much more complex or simpler based on the attributes of a particular building. The indoor space includes a plurality of wireless access points, AP1, AP2, and AP3, located at various points within indoor space 300. Each of the access points may transmit the beacon messages including identifiers as described above.

FIG. 4 depicts an example coordinate map 400 of the indoor space 300. In this example, the map may include coordinate boxes (A-E and 1-3) used to identify locations within the indoor space 300. As can be seen, access points A1, A2, and A3 are located at coordinates A3, C2, and E3 respectively.

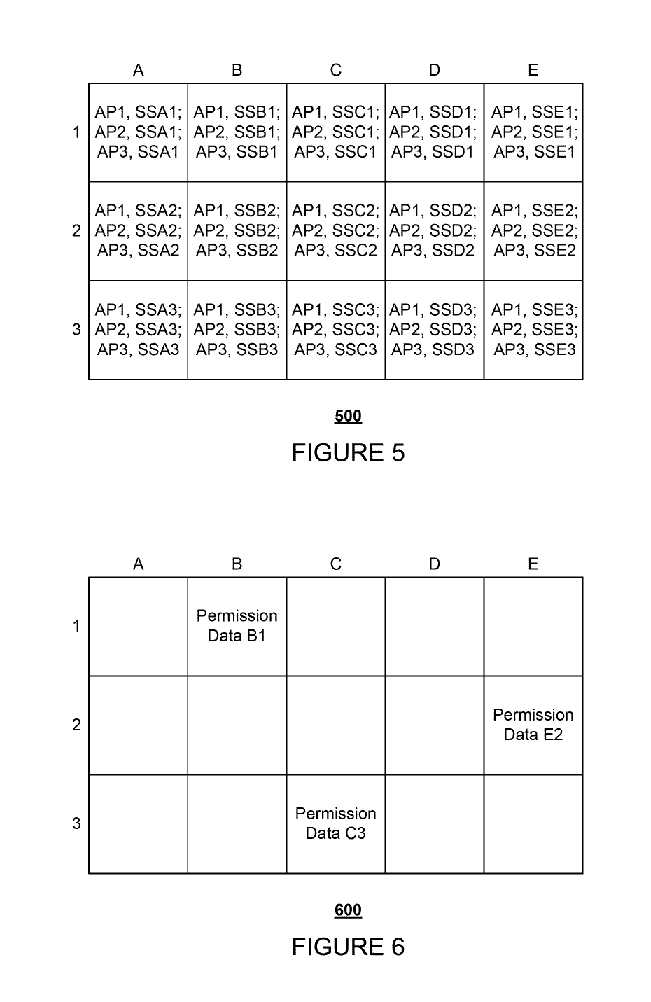

FIG. 5 depicts an example wireless network access point model 500 of the indoor space 300 based on the coordinate system of map 400. Each of the coordinate boxes of model 500 is associated with wireless network access point data. This data may be collected by walking devices through the indoor space 300 and collecting scan information. The collected scan information may then be used to generate a set of access point identifiers and corresponding signal strengths for each of the coordinate boxes of model 500. For example, at location A3, the model 500 includes data indentifying access point AP1 and its corresponding signal strength SSA3 at location A3, access point AP2 and its corresponding signal strength SSA3 at location A3, and access point AP3 and its corresponding signal strength SSA3 at location A3. Similar data is associated with each of the coordinate boxes of model 500. As described in more detail below, the wireless network access point model for an indoor space may be used to determine a client device's location in the indoor space.

While the example of indoor space 300 includes only 3 wireless network access points located on the same level, any number of wireless network access points may be used and may be located at different levels within the same or different indoor spaces. Thus, different wireless access point models for different indoor locations may include significantly more or less detail than model 500.

In addition, while the wireless network access point model is depicted herein as a grid map with coordinate boxes, various other map schemes may also be used. For example, the wireless network access point model may actually comprise a list of locations and corresponding wireless access point identifiers and signal strengths, a topographical or intensity map of wireless access point identifiers and signal strengths, one or more decision or regression trees, etc. As with the grid boxes described above, these models may also be used to determine a client device's location in an indoor space.

In other examples, rather than using a grid with boxes, determining the location of a client device with respect to a map may include predicting points along axes rather than grid squares. In other words, the grid boxes may be shrunk to points on the map and compared to latitude and longitude coordinates. In this example, the calculation of a location of a client device in the indoor space may involve calculating individual latitude and longitude coordinates one at a time or simultaneously.

The server 110 may also have access to permission data 138. This permission data may include a set of rules. The rules, as described in more detail below, the rules may be used by a permission device to grant or deny a client device some access right (for example access to a particular area of a building, the ability to use feature of the client device, etc.) or perform a task (for example open a door, delay an action, etc.).

The permission data may be associated with a particular device, user or group of devices or users. Thus, each particular user or group of users may be associated with a different set of permission data for each particular indoor space. For example, one group of users may be administrators and may be associated with permission data granting access to all areas in a building. Another group of users may be contractors associated with permission data denying access to particular areas in a building. This may be especially useful in allowing a person or group of persons access to specific areas of a building which may be updated immediately. For example, in order to allow a user access to a previously restricted area, the permission data may be updated at the server and transmitted to the client device as needed.

Permission data map 600 of FIG. 6 depicts an example set of permission data for a particular client device, such as client device 160. Map 600 is a pictorial representation of the permission data, however permission data for a particular user or group of users may be stored in various other ways such as a table, list, etc.

In the example of map 600, the permission data is associated with particular locations or areas. For example, Permission data E2 and permission data C3 are associated with locations E2 and C3, respectively. Permission Data B1/C1 is associated with the area include locations B1 and C1. As with the wireless access point models described above, the permission data may also be refined to specific points within the map of the indoor space, such that the permission data is associated with a set of one or more coordinate, such as latitude and longitude pairs.

As described in more detail below, the permission data may be used by the server to generate and transmit permission signals. The permission data may also be transmitted by the server to a client device where the client device may take action on the permission data or may generate and transmit permission signals to other devices.

In addition to the operations described below and illustrated in the figures, various operations will now be described. It should also be understood that the following operations do not have to be performed in the precise order described below. Rather, various steps may be handled in a different order or simultaneously. Steps may also be omitted or added unless otherwise stated herein.

When a client device enters an indoor space, the client device may access a wireless network access point model associated with the indoor space. For example, user may activate or log into the permission application and the client device may transmit user and location information to a server in order to download a wireless network access point model for the indoor location. This may occur automatically, for example, by detecting the user's last known location before GPS signals received by the client indicate that the device has moved indoors and using this information to request a map of the indoor space. Alternatively, a user may access the permission application and select the location of the indoor space on a map, input the name or other identifier of the indoor space such as an address, geographic location coordinates, etc. In response, the server may transmit all or a portion of the wireless network access point model to the client device. In some examples, such as where the user has previously entered the indoor space or where the wireless network access point model is packaged with the permission application, the wireless network access point model may be pre-stored at the client device.

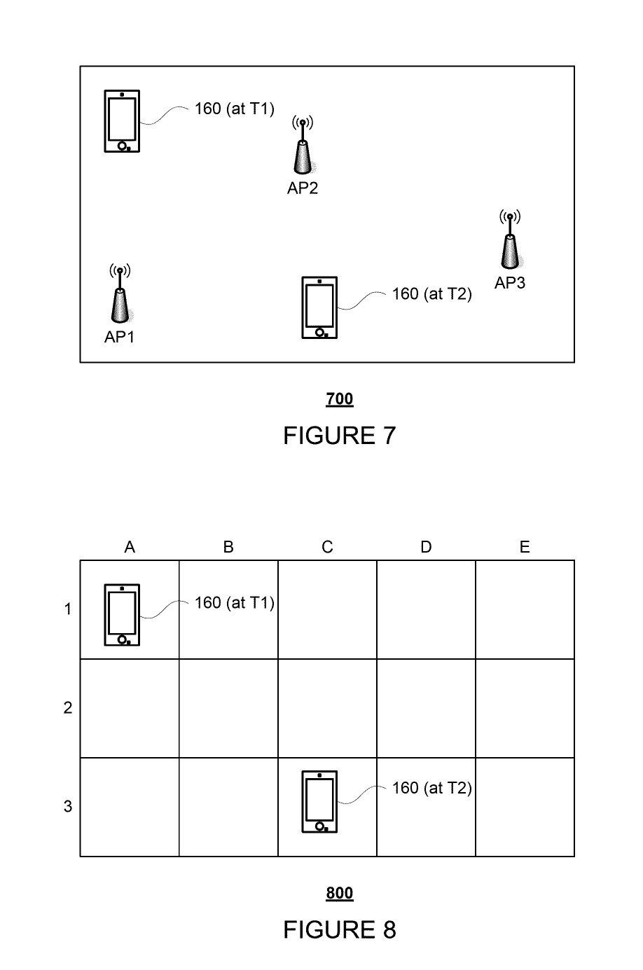

The client device may scan for wireless network access point information. When the permission application is active, these scans may occur periodically, for example, every 15 or 30 seconds. For example, map 700 of FIG. 7 is a top-down view of indoor space 300 depicting client device 160 at two different times (T1 and T2). At each of these times, client device may scan for wireless network access point information. The client device may thus identify a set of access point identifies and signal strengths for both times T1 and T2. In this example, at time T1, client device 160 identifies scan information: AP1, SSA1; AP2, SSA1; AP3, SSA1. At time T2, client device identifies scan information: AP1, SSC3; AP2, SSC3; AP3, SSC3.

The client device may determine its location within the indoor space at the time of the scan based on the scan information and the wireless network access point model. For example, using the scan information of T1, the client device may determine its location as A1, as shown in map 800 of FIG. 8. For time T2, the client device may determine the location to be C3, as shown in map 800. Again, while the examples herein use a grid map to determine the location of the client device, various other methods, including those described above, may be used.

In addition to utilizing the wireless access point models as described above, the client device may also use information from the one or more orientation devices. For example, the determination of a client device's current location in the indoor space based on the model may be an estimation associated with an error value. Information received from a gyroscope, accelerometer, compass, etc. may be used to refine this estimation and reduce the error value. Given a previous location determination, the information from the one or more orientation devices may be used to estimate the current location of the client device. This may provide a more precise location and giving a greater confidence (reducing uncertainty) in the location estimation.

The client device may transmit the identified location and user information to the server. For example, the scan information may be associated with a user identifier unique to the user or client device before being transmitted to the server. As the scans are conducted periodically, the location information may also be transmitted periodically to the server. The transmitted information may be subsequently received by the server.

The server uses the user information to identify permission data associated with the particular user or client device for the received location. If not, the server may wait for the next set of scan information and repeat this determination. If the location is associated with permission data for the particular user or client device, the server may generate a permission signal based on the permission data.

For example, the server may compare the scan information from client device 160 at time T1 to the wireless network access point model 500 and identify location A1. The server may also use the received user information to identify permission data for the client device. The location A1 may be compared to the permission data for client device 160. As location A1 is not associated with any permission data for client device 160, the server may wait to receive the next set of scan information to repeat the location determination and permission data comparison.

The server may also receive the scan information from time T2. Here, the scan data indicates that the client device is located at location C3. Again, the server may use the received user information to identify permission data for the client device. In this example, location C3 is associated with Permission Data C3.

The server may use the identified permission data to generate a permission signal and transmit the permission signal to a permission device. The permission signal may include information instructing the permission device to take some action or to grant or deny permission to take an action. The permission signal may be received by the permission device which then acts on the permission signal.

In one example, the permission device may be the client device. For example, the client device 160 and the permission device may be the same device. The client device may examine the permission signal to determine whether the client device should lock or unlock features. In one example, the client device may be restricted from sending or receiving information (such as calls, texts, accessing the Internet, etc.) or the client device may be restricted to making only emergency calls (for example to 911) and/or sending only emergency messages (for example to send for help). Such a usage may be especially helpful in certain situations where the use of mobile devices is prohibited, such as in schools, hospitals, doctor's offices, etc.

The permission signal may also include instructions to cause the client device to take some other permission-type action. For example, a client device may include a purchasing application which allows a user to make purchases (using credit card or banking information). In this example, the client device may be restricted to using the application in specific stores or checkout lines (such as one with a spending or number of products limits). Thus, if the client device is not located proximate to an approved checkout lane, the client device may use the permission signal to restrict the user of the purchasing application.

In another example, the permission device may be a different device from the client device. Here, the permission device may examine the permission signal and take some action in response. For example, if the permission device is associated with a door or door lock, the permission signal may include instructions for unlocking, not unlocking, opening, or locking a door based on the permission signal. Thus, the client device may be used as a key to the door without requiring the user to scan a badge or even remove the client device from a pocket or bag.

In another example, a first client device may send the permission signal to a second client device. In this example, the second client device may be another user's mobile phone. Having the two phones within some distance of one another may be used to create a temporary local network. As in the examples above, the presence of the second client device may unlock features on the first client device, allow the first client device to conduct a transaction, etc. In this regard, the second client device may be the permission device.

In another example, the permission device may be associated with the locks or ignition of a vehicle. For example, the client device may send a signal to the permission device to unlock and start the vehicle. This may allow, for example, a valet to move vehicles in a hotel garage, without requiring the key, but nowhere else.

In another example, the permission signal may instruct the permission device to delay an action. For example, the permission device may include a vehicle such as a train, plane, bus or car. The permission vehicle may use the permission signal to delay departure or wait for the client device to arrive. For example, if there is a passenger who is located within a particular distance from a train platform, airport gate, or bus stop, the permission signal may cause the permission vehicle to wait some reasonable period of time for the passenger. In some cases, the permission vehicle may wait to determine whether it receives enough permission signals from different client devices to determine whether or not it should delay its departure.

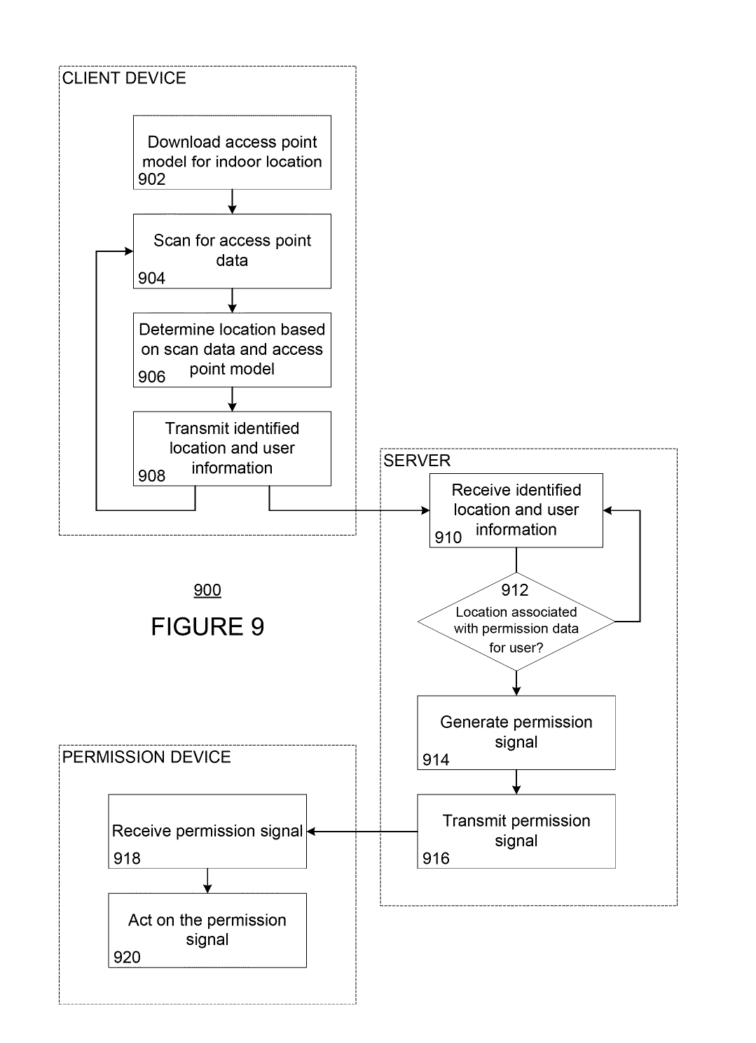

Flow diagram 900 of FIG. 9 is an example of some of the features discussed above. In this example, a client device downloads an access point model for an indoor location at block 902. The client device then scans for access point data at block 904. The client device determines its location with respect to the indoor location based on the scan data and access point model at block 906. The client device transmits the identified location and user information identifying the client device or the user to a server at block 906.

At block 910, the server receives the identified location and the user information. If the identified location is not associated with permission data for the user at block 912, the server returns to block 910 to wait for new information from a client device. Although not shown, the server may transmit information to the client device to indicate that no permission data is available for the identified location and user information. If the identified location is associated with permission data for the user information, the server may generate a permission signal at 914 and transmit the permission signal to a permission device at block 916. The permission signal may instruct the permission device to grant the client device some access, such as opening a door, etc. as described above. At block 918, the permission device may receive the permission signal and at block 920, the permission device may act on the permission signal, for example, opening a door proximate the identified location.

Rather than determining the location at the client device, the client device may simply send the scan information to the server with the user information. In this example, the user or client device may activate the permission application, such as by using one of the examples described above. The activation or login process may send some information to the server to indicate the general location of the client device, such as last known GPS location or user selection or input of an address or identification of a building. The client device may then scan for the wireless network access point data and transmit the scan information to the server with the user information. For example, the client device may scan and transmit the scan data periodically, such as every minute or every few seconds. The scans may also be prompted by a user, for example, by accessing the permission application on the client device.

The server identifies a map for an indoor location based on the login information. Using the received scan information and the identified map, the server identifies a location of the identified map. The server may also identify permission data for the particular user or client device based on the received user information. The server may the n determine whether the identified location is associated with the identified permission data and the process may proceed as described in the examples above.

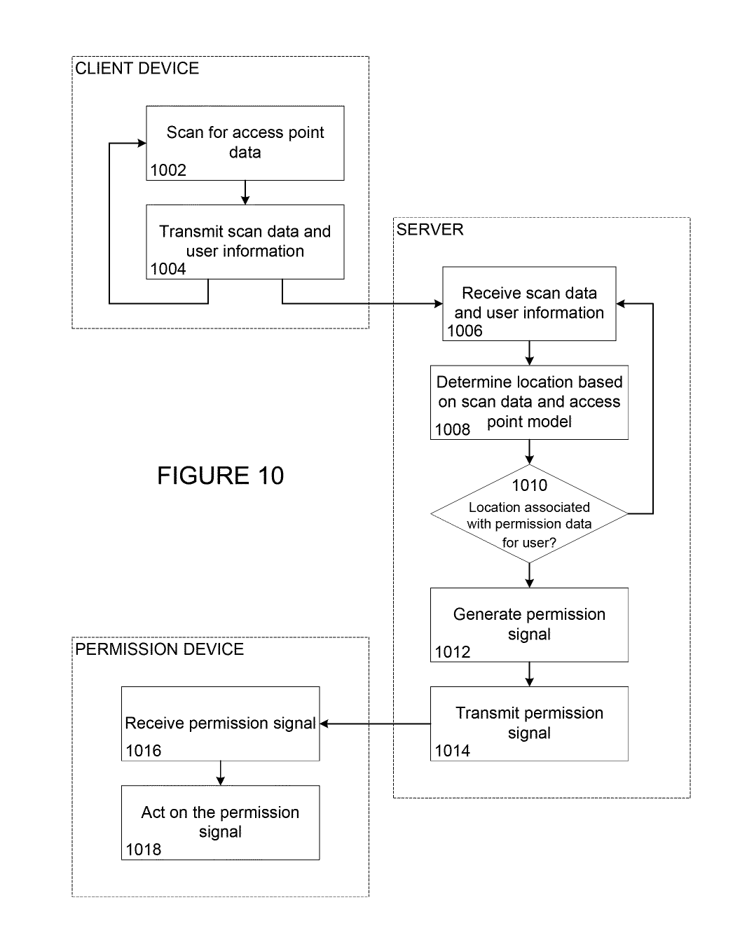

Flow diagram 1000 of FIG. 10 is an example of some of the features discussed above. In this example, a client device in an indoor location scans for access point data at block 1002. The client device transmits the scan information and user information identifying the client device or the user to a server at block 1004. The client device then returns to block 1002 to conduct a new scan.

At block 1006, the server receives the scan information and the user information. The server then determines a location based on the received scan data and an access point model for the indoor location at block 1008. If the identified location is not associated with permission data for the user at block 1010, the server returns to block 1006 to wait for new information from a client device. Although not shown, the server may transmit information to the client device to indicate that no permission data is available for the identified location and user information. If the identified location is associated with permission data for the user information, the server may generate a permission signal at 1012 and transmit the permission signal to a permission device at block 1014. At block 1016, the permission device may receive the permission signal and at block 1018, the permission device may act on the permission signal.

In other examples, the client device may perform the comparing of permission data to an identified location rather than the server. For example, during the login or activation process for the permission application, the client device may transmit user information as well as general location identifier (last geolocation coordinates, an address, identification of a building, or other location code which may be used to identify an indoor location) to a server. The server may use the general location information to identify a wireless network access point model for an indoor location. The identified wireless network access point model and user information may then be used to identify permission data associated with the user or the user's client device. The wireless network access point model and the permission data may be transmitted to the client device. The client device may receive the wireless network access point model and the permission data and store it for later use.

As described above, once within an indoor space, the client device may scan for wireless network access point information. The client device may then use the scan information to identify a location of the received wireless network access point model. If there are more than one maps stored in the client device, the client device may first select a map based on user input, last known GPS location, etc. The client device may compare the location to the received permission data. If there is no permission data associated with the location, the client device may wait for the next set of scan information. If there is permission data associated with the location, the client device may user the permission data to generate a permission signal. The client device may also transmit the permission signal to a permission device. Upon receipt of the permission signal, the permission device may act on the permission signal, for example, as described in the examples above.

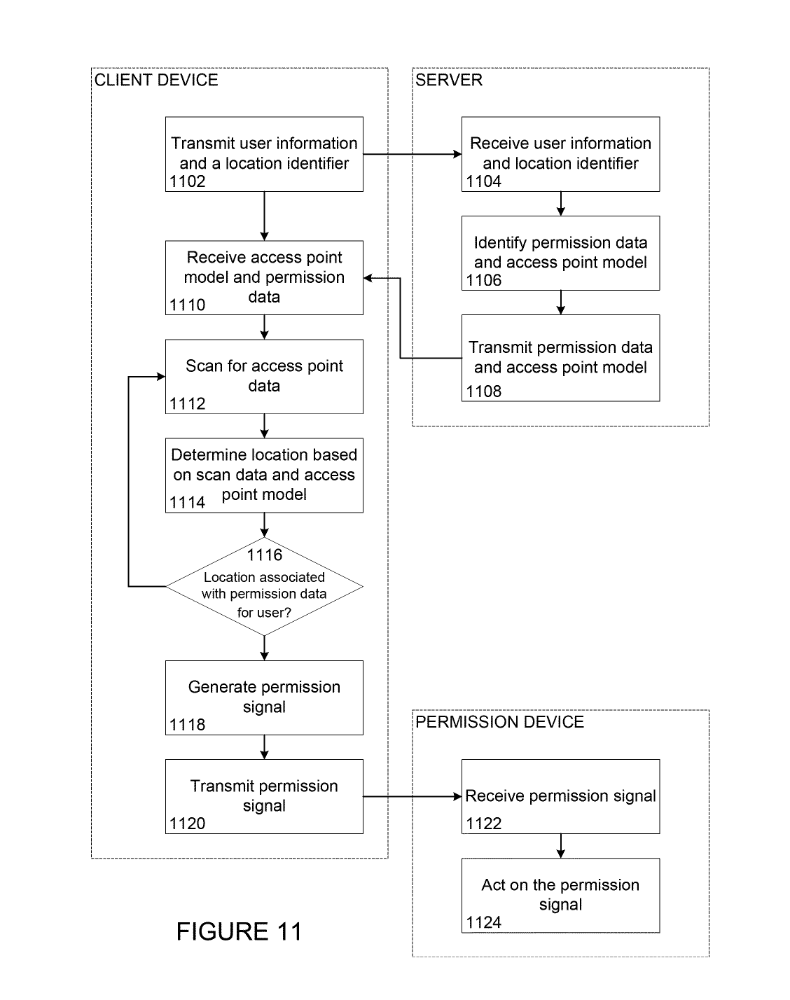

Flow diagram 1100 of FIG. 11 is an example of some of the features discussed above. In this example, a client device transmits user information and a location identifier to a server at block 1102. The server uses the location identifier to identify an access point model for an indoor location and permission data associated with the user at block 1108. The permission data and the access point model are transmitted by the server and received by the client device at blocks 1108 and 1110, respectively.

The client device then scans for access point data at block 1112. The client device determines its location with respect to the indoor location based on the scan data and access point model at block 1114. If the identified location is not associated with permission data for the user at block 1116, the client device returns to block 1112 conduct a new scan. Although not shown, the client device may notify a user of the client device, for example, by displaying a message indicating that no permission data is available for the identified location and user information. If the identified location is associated with permission data for the user information, the client device may generate a permission signal at 1118 and transmit the permission signal to a permission device at block 1120. At block 1122, the permission device may receive the permission signal and at block 1124, the permission device may act on the permission signal.

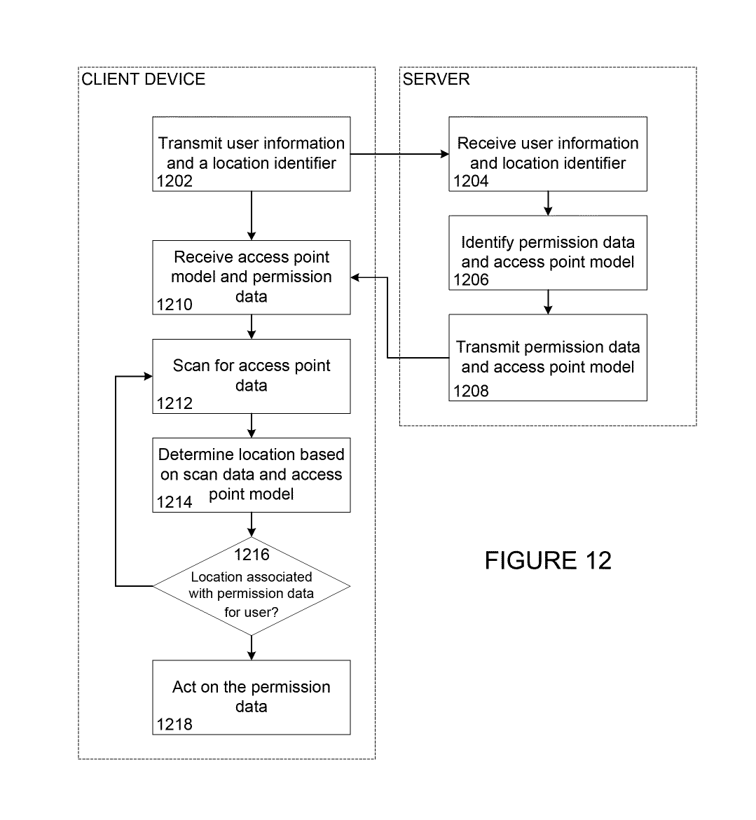

In some examples, the client device may compare the identified location to the permission data, but rather than generating and transmitting a permission signal, the client device may simply act on the permission data. For example, flow diagram 1200 of FIG. 12 is an example of such a process. In this example, a client device transmits user information and a location identifier to a server at block 1202. The server uses the location identifier to identify an access point model for an indoor location and permission data associated with the user at block 1208. The permission data and the access point model are transmitted by the server and received by the client device at blocks 1208 and 1210, respectively.

The client device then scans for access point data at block 1212. The client device determines its location with respect to the indoor location based on the scan data and access point model at block 1214. If the identified location is not associated with permission data for the user at block 1216, the client device returns to block 1212 conduct a new scan. Although not shown, the client device may notify a user of the client device, for example, by displaying a message indicating that no permission data is available for the identified location and user information. If the identified location is associated with permission data for the user information, the client device may act on the permission signal as shown in block 1218.

In some examples information received from the one or more orientation devices of the client device may also be used to determine a mode of use for the phone. For example, the information from the one or more orientation devices may be compared to various models to determine whether and how the client device is being held or carried, such as if the client device is in a person's hand, pocket, bag, etc. while he or she is walking, running, jogging, etc. These models may be generated by recording measurements from one or more orientation devices as a client device is held in various positions and/or moved around.

The mode information may be used in various ways. For example, referring to FIG. 9, in addition to transmitting the identified location and user information at block 908, the client device may also transmit information received from the one or more orientation devices. This information may be received by the server at block 910, and subsequently used to determine the mode of the client device. In this regard, the server may determine whether there is any permission data for this user when the client device is in the determined mode. In the door example, if the mode of the client device is in a person's hand and while the person is walking, the door may be opened for the person. Similarly, if the mode of the client device is in a person's bag while the person is running or jogging, the door may remain closed. In this example, it may be unsafe to allow the person who is moving quickly and possibly not paying attention to go through the door until he or she has slowed down and is holding the client device in his or her hand.

Similarly, in the example of FIG. 10, in addition to transmitting the scan data and user information at block 1004, the client device may also transmit information received from the one or more orientation devices. This information may be received by the server at block 1006, and subsequently used to determine the mode of the client device. In this regard, the server may determine whether there is any permission data for this user when the client device is in the determined mode before generating the permission signal.

Referring to the examples of FIGS. 11 and 12, the client device may receive information from the one or more orientation devices and may use this information to determine the mode of the client device. At blocks 1116 or 1216, the client device may determine whether there is any permission data for the identified location when the client device is in the determined mode before generating the permission signal (as in FIG. 11) or acting on the permission data (as in FIG. 12).

As these and other variations and combinations of the features discussed above can be utilized without departing from the subject matter defined by the claims, the foregoing description of exemplary implementations should be taken by way of illustration rather than by way of limitation of the subject matter defined by the claims. It will also be understood that the provision of the examples described herein (as well as clauses phrased as “such as,” “e.g.”, “including” and the like) should not be interpreted as limiting the claimed subject matter to the specific examples; rather, the examples are intended to illustrate only some of many possible aspects.

1. A method for generating permission signals associated with an indoor space, the method comprising:
receiving user information identifying a user;
receiving scan information including wireless network access points and associated signal strengths, wherein the scan information is from a scan of the indoor space;
determining a location by comparing the scan information to a model of the indoor space, the model including wireless network access points and signal strengths for locations in the indoor space;
identifying permission data associated with a user of a client device based on the user information, the permission data identifying a set of locations of in the indoor space, each particular location of the set of locations being associated with a particular rule;
identifying a rule based on the determined location;
generating, by a processor, a permission signal based on the rule, wherein the permission signal includes instructions concerning permission to perform some task; and
transmitting the permission signal to a permission device for further action on the permission signal.

2. The method of claim 1, wherein the processor that generates the permission signal is a processor of the client device.

3. The method of claim 1, wherein the processor that generates the permission signal is a processor of a server computer that receives the scan information from the client device.

4. The method of claim 1, wherein the permission signal includes information instructing the permission device to unlock a door.

5. The method of claim 1, wherein the permission signal includes information instructing the permission device not to unlock a door.

6. The method of claim 1, wherein the permission signal includes information instructing the permission device to delay an action of the permission device.

7. The method of claim 1, wherein the permission signal includes information instructing the permission device to deny a transaction associated with the user.

8. The method of claim 1, further comprising determining a distance between the identified location and the location of the permission device, wherein the permission signal is further generated based on the determined distance.

9. The method of claim 1, further comprising receiving a request to delay an action from a pre-determined number of client devices wherein the permission signal is further generated only after the information received from the pre-determined number of client devices.

10. The method of claim 1, further comprising:
receiving orientation information from one or more orientation devices;
comparing the received orientation information to a mode model to determine a mode of the client device, wherein the mode model defines how the client device is being carried by the user; and
wherein identifying the permission data is further based on the determined mode of the client device.

11. The method of claim 1, wherein determining the location by comparing the scan information to a model of the indoor space, the model including wireless network access points and signal strengths for locations in the indoor space, includes calculating a latitude coordinate and a longitude coordinate.

12. A method comprising:
receiving user information identifying a user;
scanning for scan information including wireless network access points and associated signal strengths;
determining, by a processor, a location by comparing the scan information to a model of an area at which the scanning was performed, the model including wireless network access points and signal strengths for locations of the area;
identifying permission data associated with a user of a client device based on the user information, the permission data identifying a set of locations of the area, each particular location of the set of locations being associated with a particular rule defining an access right to a feature of the client device;
identifying a rule based on the determined location; and
performing an action based on the access right to the feature of the client device associated with the identified rule.

13. The method of claim 12, wherein the identified rule involves restricting the ability to make telephone calls at the client device and the action is denying the user the ability to make non-emergency telephone calls at the client device.

14. The method of claim 12, wherein the identified rule involves restricting the ability to send or receive text messages at the client device and the action is denying the user the ability to send and receive text messages.

15. The method of claim 12, wherein the identified rule involves restricting the ability to complete a business transaction using the client device and action includes denying the user the ability to complete a business transaction associated with the user.

16. The method of claim 12, wherein the identified rule involves enabling the user to complete a business transaction using the client device and action includes enabling the user to complete a business transaction associated with the user.

17. The method of claim 12, further comprising:
transmitting a request to a server, the request including the user information and information identifying the area;
in response to the request, receiving the map of the area and the permission information.

18. The method of claim 12, further comprising:
receiving orientation information from one or more orientation devices;
comparing the received orientation information to a mode model to determine a mode of the client device, wherein the mode model defines how the client device is being carried by the user and how the user is moving through the area; and
wherein identifying the permission data is further based on the determined mode of the client device.

19. The method of claim 12, wherein determining the location by comparing the scan information to the model of the area, the model including wireless network access points and signal strengths for locations in the area, includes calculating a latitude coordinate and a longitude coordinate.

20. A tangible computer-readable storage medium on which computer readable instructions of a program are stored, the instructions, when executed by a processor, cause the processor to perform a method of generating permission data associated with an indoor space, the method comprising:
receiving user information identifying a user;
receiving scan information including wireless network access points and associated signal strengths, wherein the scan information is from a scan of the indoor space;
determining a location by comparing the scan information to a model of the indoor space, the model including wireless network access points and signal strengths for locations in the indoor space;
identifying permission data associated with a user of a client device based on the user information, the permission data identifying a set of locations of in the indoor space, each particular location of the set of locations being associated with a particular rule;
identifying a rule based on the determined location;
generating a permission signal based on the rule, wherein the permission signal includes instructions concerning permission to perform some task; and
transmitting the permission signal to a permission device for further action on the permission signal.

21. A tangible computer-readable storage medium on which computer readable instructions of a program are stored, the instructions, when executed by a processor, cause the processor to perform a method, the method comprising:
receiving user information identifying a user;
scanning for scan information including wireless network access points and associated signal strengths;
determining a location by comparing the scan information to a model of an area at which the scanning was performed, the model including wireless network access points and signal strengths for locations in the area;
identifying permission data associated with a user of a client device based on the user information, the permission data identifying a set of locations of in the area, each particular location of the set of locations being associated with a particular rule defining an access right to a feature of the client device;
identifying a rule based on the determined location; and
performing an action based on the access right to the feature of the client device associated with the identified rule.

22. A device comprising:
memory storing a model of an indoor space, the model including wireless network access points and signal strengths for locations in the indoor space, the memory further storing permission data associated with a user of the device, the permission data identifying a set of locations of in the indoor space, each particular location of the set of locations being associated with a particular rule;
a processor coupled to the memory, the processor being configured to:
collect scan information including wireless network access points and associated signal strengths, wherein the scan information is collected from a scan of the indoor space;
determine a location by comparing the scan information to the model of the indoor space; and
identify a rule from the stored permission data based on the determined location.

23. The device of claim 22, wherein the processor is further configured to perform an action based on the access right to the feature of the device associated with the identified rule.

24. The device of claim 22, wherein the processor is further configured to:
generate a permission signal based on the rule, wherein the permission signal includes instructions concerning permission to perform some task; and
transmit the permission signal to a permission device for further action on the permission signal.

25. A device comprising:
memory storing a model of an indoor space, the model including wireless network access points and signal strengths for locations in the area, the memory further storing sets of permission data, each set of permission data being associated with a given user and identifiable based on user information for the given user, and each set of permission data further identifying a set of locations of in the area, each particular location of the set of locations being associated with a particular rule;
a processor coupled to the memory, the processor being configured to:
receive user information and scan information including wireless network access points and associated signal strengths, wherein the scan is conducted in the area;
identify permission data associated based on the received user information;
determine a location by comparing the scan information to the model of the area; and
identify a rule from the identified permission data based on the determined location.

26. The device of claim 25, wherein the processor is further configured to perform an action based on the access right to the feature of the device associated with the identified rule.

27. The device of claim 25, wherein the processor is further configured to:
generate a permission signal based on the rule, wherein the permission signal includes instructions concerning permission to perform some task; and
transmit the permission signal to a permission device for further action on the permission signal.
